(19) United States
(12) Patent Application Publication
(10) Pub. No.: US 2004/0239074 A1
(43) Pub. Date: Dec. 2, 2004

(54) Air bag gooseneck hitch

(76) Inventors: Thomas W. Lindenman, South Bend, IN (US); Richard W. McCoy, Granger, IN (US)

Correspondence Address: KING & SCHICKLI, PLLC, 247 NORTH BROADWAY, LEXINGTON, KY, 40507, US

(21) Appl. No.: 10/767,941

(22) Filed: Jan. 29, 2004

Related U.S. Application Data
(60) Provisional application No. 60/443,321, filed on Jan. 29, 2003.

(51) Int. Cl. B60D 1/00

(52) U.S. Cl. 280/491.1

(57) ABSTRACT

A hitch assembly is mounted beneath a bed of a truck. The hitch assembly includes a frame, a platform displaceable relative to the frame, a hitch ball carried on the platform and an expandable body carried on the frame between a portion of the frame and the platform. By expanding the expandable body the platform and hitch ball are raised into a towing position. By contracting the expandable body, the platform and hitch ball are lowered into a storage position.

This application claims the benefit of U.S. Provisional Patent Application Serial No. 60/443,321 filed Jan. 29, 2003.

### TECHNICAL FIELD

The present invention relates generally to the towing field and, more particularly, to a new gooseneck hitch assembly for installation on a vehicle.

### BACKGROUND OF THE INVENTION

Ball hitches of the gooseneck type wherein the hitch ball is mounted in the bed of a pickup truck between the rear wheels of the truck are well known in the art. An example of such a hitch is found in U.S. Pat. No. 6,199,890 Lindenman et al. entitled “Gooseneck Hitch Assembly” and assigned to the assignee of the present invention. This patent discloses a gooseneck hitch assembly including a hitch ball, a housing and a mounting assembly for securing the hitch ball and housing to the frame of the vehicle. The hitch ball is pivotally connected to the housing and includes a conveniently located lubrication fitting, a pivotally mounted security door with a torsion spring to hold the door in fully open and closed positions and latch thereon for securing the door in a closed position and the hitch ball in a towing position.

The present invention relates to a very simple gooseneck hitch assembly wherein only a very small opening needs to be cut in the truck bed. Specifically, the opening need only provide sufficient clearance for the passage of the hitch ball which is moved vertically between an extended or towing position and a retracted or storage position.

### SUMMARY OF THE INVENTION

In accordance with the purposes of the present invention as described herein, the hitch assembly is provided for mounting beneath the bed of a pickup truck. The hitch assembly comprises a frame and a platform displaceable relative to the frame. In addition, the hitch assembly includes a hitch ball that is carried on the platform. Further, an expandable body is carried on the frame between a portion of the frame and the platform. By expanding the expandable body, the platform is displaced relative to the frame to a towing position with the hitch ball extending upwardly through a hole in the bed of the pickup truck to which the hitch assembly is mounted. In contrast, by contracting the expandable body, the platform is displaced or lowered to a storage position with the hitch ball retracted below the bed of the pickup truck. In this position, the bed is clear of any interference from any portion of the hitch assembly including the hitch ball and is thereby fully free for unobstructed use such as for carrying sheets of plywood or any other materials.

The hitch assembly may further include at least two guide posts that are held by the frame. Further, the platform may include at least two apertures or other appropriate structures for sliding along the at least two guide posts. Still further, the hitch assembly includes a pump for pumping fluid into the expandable body to thereby raise the hitch ball and a valve for releasing fluid from the expandable body to thereby lower the hitch ball.

In accordance with still another aspect of the present invention a method of raising and lowering. a hitch ball between towing and storage positions is provided. That method comprises the steps of filling an expandable body with fluid to raise the hitch ball and releasing fluid from an expandable body to lower the hitch ball.

Still other benefits and advantages of the present invention will become readily apparent to those skilled in this art from the following description wherein there is shown and described three possible embodiments of this invention simply by way of illustration of three of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of the specification, illustrate several aspects of the present invention and together with the description serve to explain the principles of the invention. In the drawings:

FIG. 1 is a schematical partially cross-sectional view showing the hitch assembly of the present invention with the hitch ball in the retracted, storage position so that the top of the hitch ball is substantially flush with the upper or deck surface of the bed of the pickup truck;

FIG. 2 is a view similar to FIG. 1 but showing the hitch assembly with the hitch ball in the towing position so that the hitch ball projects upwardly through a hole in the bed of the pickup truck;

FIG. 3 is a schematical view of the control circuit for raising and lowering the hitch ball between the storage and towing positions;

FIG. 4 is a top plan view (with top wall removed) of an alternative embodiment of the present invention;

FIG. 5 is a schematical and partially cross-sectional view of the alternative embodiment illustrated in FIG. 4;

FIG. 6 is a top plan view (with top wall moved) of yet another alternative embodiment of the present invention; and

FIG. 7 is a schematical and partially sectional view of the alternative embodiment illustrated in FIG. 6.

Reference will now be made in detail to the present preferred embodiment of the invention, an example of which is illustrated in the accompanying drawings.

### DETAILED DESCRIPTION OF THE INVENTION

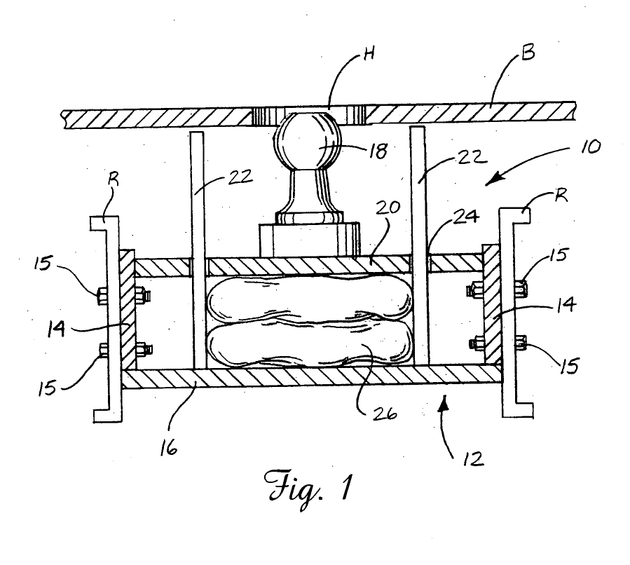

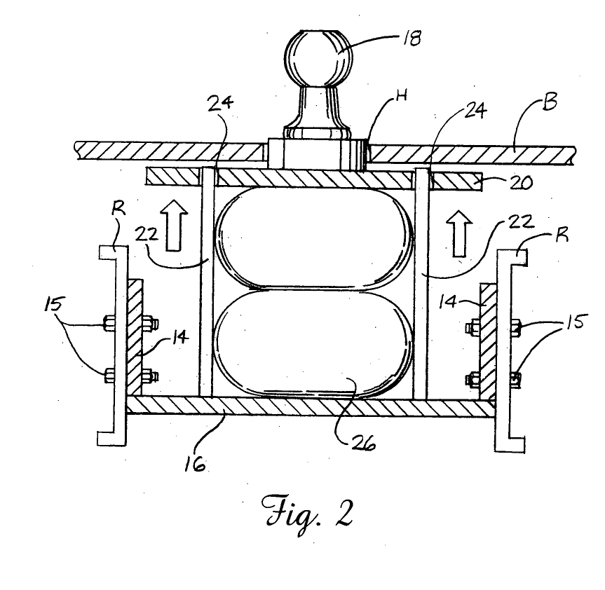

Reference is now made to FIGS. 1 and 2 schematically illustrating the hitch assembly 10 of the present invention. The hitch assembly 10 is secured beneath the bed B of a pickup truck between the frame rails R of the pickup truck. The frame 12 includes four side walls 14 (only one shown in the. drawing figures) and a bottom wall 16. While the side walls 14 are shown as extending upwardly from the bottom wall 16 only about half way to the bed B of the pickup truck, it should be appreciated that the side walls 14 may extend all the way from the bottom wall 16 to the bed B as solid walls or as an open cage so as to provide support for the expandable body 26 described below in greater detail. The hitch assembly 10 may be secured to the frame rails R of the pickup truck utilizing any means of fastening known in the art to be appropriate for the intended purpose including but not limited to cooperating nut and bolt fasteners 15 as illustrated, screws, welding or the like.

The hitch assembly 10 also includes a hitch ball 18 adapted for connection to a gooseneck towing socket as commonly found on a trailer. The hitch ball 18 is mounted or carried on a platform or base 20 by welding, bolting or other means. As illustrated, the platform 20 is in the form of a large plate. The platform 20 and the hitch ball 18 are displaceable together relative to the frame 12. Specifically, two rigid guides such as posts 22 are secured by welding, bolting or other means to the frame 12 at opposing side walls 14 and/or at opposing positions along the base wall 16. The guide posts 22 extend vertically upward from the bottom wall 16 nearly all the way to the bed B of the pickup truck. The platform 20 includes apertures 24 through which the guide posts 22 extend. The apertures 24 provide sufficient clearance for the guide posts 22 to allow the platform 20 to slide freely along the guide post 22.

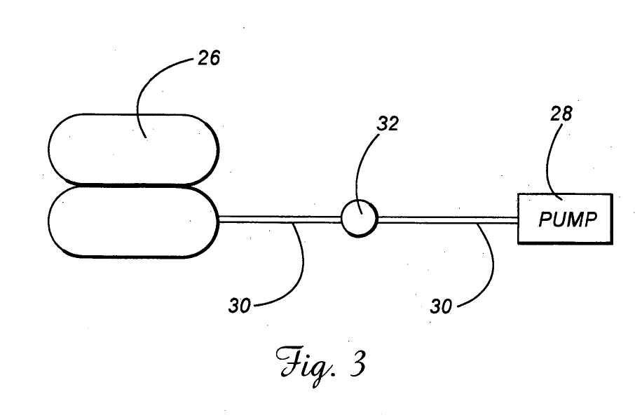

An expandable body or bladder 26, such as an air bag, is held in the frame 12. A first end of the expandable body 26 engages the bottom wall 16 of the frame while a second, opposite end of the air bag engages the lower face of the platform 20. As best shown in FIG. 3, the expandable body 26 is connected to a fluid pump 28 by means of a conduit 30. In one possible embodiment the pump 28 is an air pump that may be selectively activated to pump air from the environment into the expandable body 26 causing the expandable body to inflate and expand. When the expandable body 26 is fully expanded the pump 28 is deactivated. During expansion, the platform 20 and hitch ball 18 are raised together (i.e. vertically translated without pivoting) from the storage position shown in FIG. 1 to the towing position shown in FIG. 2.

In the towing position, the platform 20 is pressed against the bottom of the bed B of the pickup truck and the hitch ball 18 projects through a hole H in the bed B and extends up above the bed. In this position a gooseneck trailer tongue may be secured to the hitch ball 18 in a manner known in the art to allow the towing of a trailer behind the vehicle to which the hitch assembly 10 is mounted. Advantageously, during towing the air bag and fluid provide improved driving characteristics by dampening road vibrations thereby smoothing the ride and performance of the vehicle during towing and increasing the comfort of the driver and passengers in the towing vehicle.

After disconnection from a trailer, the hitch ball 18 may be retracted from the towing position shown in FIG. 2 to the storage position shown in FIG. I if desired. Specifically, with the pump 28 deactivated, a valve 32 provided in the conduit 30 may be opened to release air pressure in the expandable body 26 into the environment. As the air pressure is released, the expandable body 26 contracts under the weight of the platform 20 and hitch ball 18 until the hitch ball is lowered into the storage position shown in FIG. 1 with the top of the hitch ball below or substantially flush with the top or deck surface of the bed B of the pickup truck. If desired a plug of rubber or other material may be utilized to close the hole H. In this position, it should be appreciate that no component parts of the hitch assembly 10 extend above the bed B where they might otherwise interfere with the carrying of cargo. While this interference is not a problem with many different material loads, it should be appreciated that this can be a significant concern when one is seeking to haul sheet material such as plywood flat on the bed of the pickup truck.

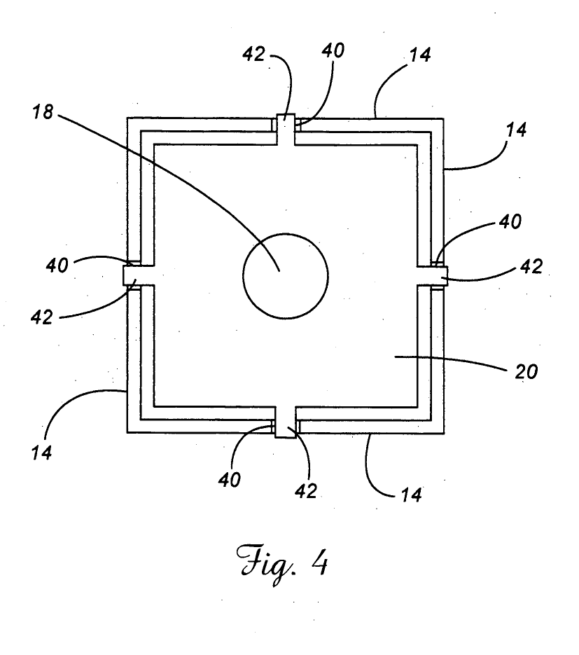

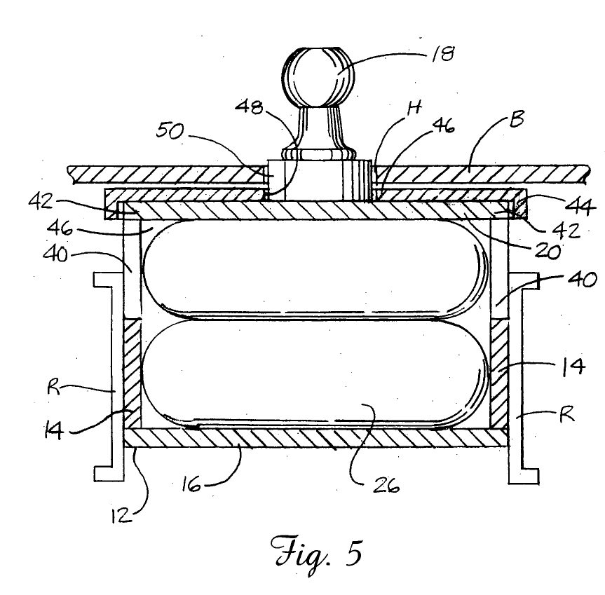

One possible alternative embodiment of the hitch assembly 10 of the present invention is illustrated in FIGS. 4 and 5. In this embodiment, the frame 12 includes a series of four sidewalls 14, a bottom wall 16 and a top wall 44 defining a cavity or chamber 46. The cavity 46 receives and holds the expandable body or bladder 26 and the platform 20 that carries the hitch ball 18. An aperture 47 in the top wall 44 provides the necessary clearance to allow the hitch ball 18 to pass freely through the top wall. At the same time, the edge 48 of the top wall 44 defining the aperture 47 engages the base 50 of the hitch ball 18 if it is deflected slightly in any direction thereby further stabilizing the hitch ball 18 in the desired position.

As illustrated, at least two or as many as all four of the sidewalls 14 include guide slots 40. The platform 20 also includes a cooperating guide tab 42 for free sliding movement along each guide slot 40. The cooperating slots 40 and tabs 42 function to guide the platform 20 as it is moved by the expandable body or bladder 26 between the raised and lowered positions in the same manner as the first embodiment illustrated in FIGS. 1-3 and described above.

The embodiment illustrated in FIGS. 4 and 5 is assembled by placing the expandable body or bladder 26 in the cavity 46 formed by the sidewalls 14 and bottom wall 16. Next, the air pressure line 30 is connected to the body or bladder 26 through one of the sidewalls 14 or the bottom wall 16.

Next, the platform 20 is positioned on top of the body or bladder 26 in the cavity 46. This is done by carefully aligning the tabs 42 on the platform 20 with the open end of the slots 40 in the sidewalls 14.

The top wall 44 is then positioned over the sidewalls 14 while the hitch ball 18 is passed through the aperture 46. The top wall 44 is then secured to the sidewalls 14 by screws, bolts, welding or other appropriate means. The hitch assembly 10 is then ready for mounting to the frame rails R of a vehicle.

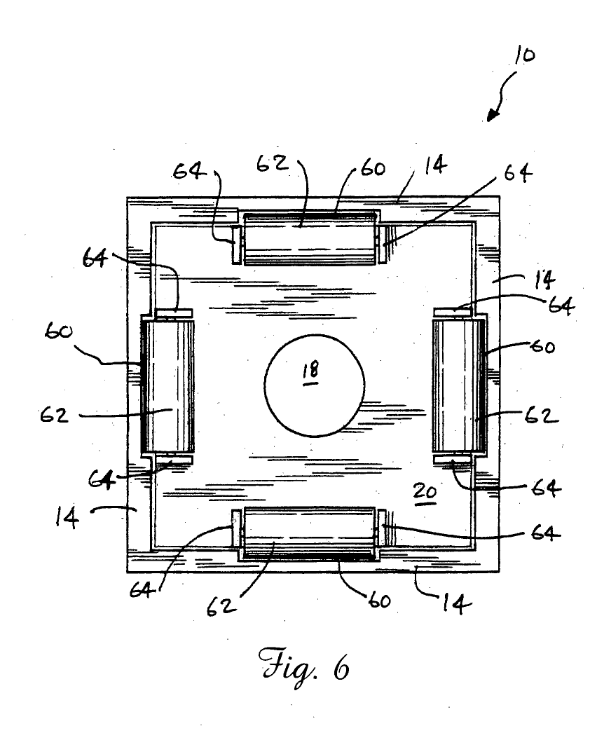

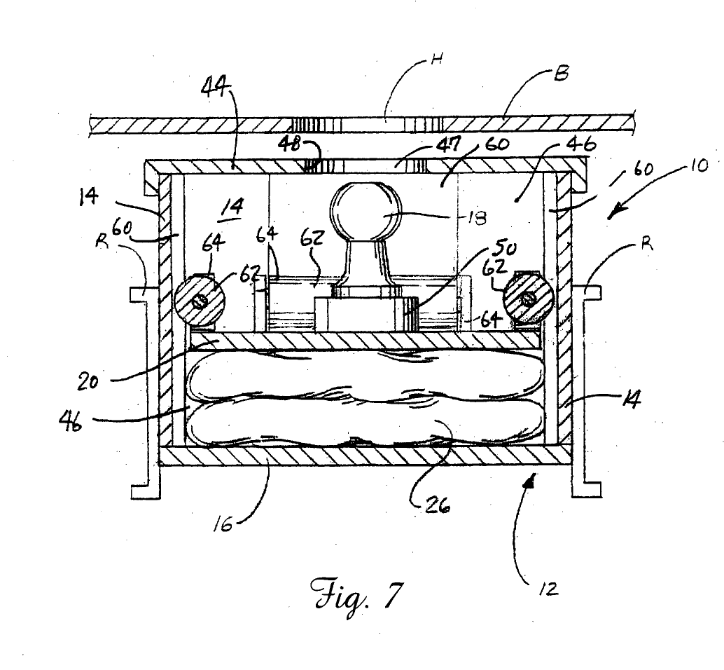

Yet another possible alternative embodiment is illustrated in FIGS. 6 and 7. In this embodiment, the frame 12 includes a series of four sidewalls 14, a bottom wall 16 and a top wall 44 defining a cavity or chamber 46. The cavity 46 receives and holds the expandable body or bladder 26 and the platform 20 that carries the hitch ball 18. An aperture 47 in the top wall 44 provides the necessary clearance to allow the hitch ball 18 to pass freely through the top wall. At the same time, the edge 48 of the top wall 44 defining the aperture 47 engages the base 50 of the hitch ball 18 if the hitch ball is deflected slightly in any direction thereby further stabilizing the hitch ball 18 in the desired position.

As illustrated, at least two or as many as four of the sidewalls 14 include guide channels 60. A corresponding number of rollers 62 are held in mounting blocks 64 on the platform 20. Each of the rollers 62 freely rotates in the blocks 64 relative to the platform 20. The rollers 62 and guide channels 60 function to guide the platform 20 as it is moved by the expandable body or bladder 26 between the raised and lowered positions in the same manner as the first embodiment illustrated in FIGS. 1-3 and described above. The rollers 62 function to allow low friction, free-sliding movement of the platform 20 between the sidewalls 14.

The foregoing description of three possible embodiments of the invention has been presented for purposes of illustration and description. It is not intended to be exhaustive or to limit the invention to the precise form disclosed. Obvious modifications or variations are possible in light of the above teachings. For example, while two guide posts 22 are shown and described, other numbers of guide posts could be provided. Further, while simple apertures 24 are provided in the platform 20 for following the guide posts 22, it should be appreciated that other structures could be utilized. For example, the guide posts 22 could form partially enclosed tracks and the platform 20 could include track following elements projecting into the tracks.

Still further, sliding surfaces of the platform 20 and/or the guide posts 22/guide slots 40 may be coated, lined or otherwise treated with a low friction material such as polytetrafluoroethylene or nylon. Thus, for example, the portion of the platform 20 defining the apertures 24, the edges of the guide tabs 42 and/or the outer edges of the platform adjacent the walls 14 may include such a coating.

The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed is:

1. A hitch assembly for mounting to a vehicle, comprising:
a frame;
a platform displaceable relative to said frame;
a hitch ball carried on said platform; and
an expandable body carried on said frame between a portion of said frame and said platform whereby expanding said expandable body causes said platform to be displaced to a towing position and contracting said expandable body causes said platform to be displaced to a storage position.

2. The hitch assembly of claim 1 wherein at least two guides are held by said frame and said platform includes at least two apertures for sliding along said at least two guides.

3. The hitch assembly of claim 1, wherein said portion of said frame is a bottom wall.

4. The hitch assembly of claim 1, further including a pump for pumping fluid into said expandable body.

5. The hitch assembly of claim 4, further including a valve for releasing fluid from said expandable body.

6. The hitch assembly of claim 1, wherein said frame includes at least one guide slot and said platform includes at least one guide tab received in and freely sliding along said at least one guide slot.

7. The hitch assembly of claim 1, wherein said frame includes a top wall, a bottom wall and four sidewalls defining a cavity receiving and holding said expandable body and said platform.

8. The hitch assembly of claim 7, wherein at least one guide slot is provided in at least one of said sidewalls and said platform includes at least one guide tab received in and freely sliding along said at least one guide slot.

9. The hitch assembly of claim 8, wherein said top wall includes an aperture allowing free passage of said hitch ball.

10. The hitch assembly of claim 9, wherein said top wall includes an edge defining said aperture and closely surrounding a base of said hitch ball when said hitch ball is raised into said towing position.

11. The hitch assembly of claim 1, wherein said frame includes at least two guide channels and said platform carries at least two guide rollers received in and freely rolling along said at least two guide channels.

12. The hitch assembly of claim 1, wherein said frame includes a top wall, a bottom wall and four sidewalls defining a cavity receiving and holding said expandable body and said platform.

13. The hitch assembly of claim 12, wherein a first guide channel is provided in a first of said four sidewalls and a second guide channel is provided in a second of said four sidewalls and further wherein said platform carries at least two guide rollers received in and freely rolling along said at least two guide channels.

14. The hitch assembly of claim 13, wherein said top wall includes an aperture allowing free passage of said hitch ball.

15. The hitch assembly of claim 14, wherein said top wall includes an edge defining said aperture and closely surrounding a base of said hitch ball when said hitch ball is raised into said towing position.

16. A hitch assembly, comprising:
a frame;
a hitch ball; and
an expandable body for selectively displacing said hitch ball between a towing position and a storage position.

17. The hitch assembly of claim 16, further including a pump and a valve for expanding and contracting said expandable body.

18. The hitch assembly of claim 17, further including means for guiding said hitch ball between said towing position and said storage position.

19. The hitch assembly of claim 16, further including means for guiding said hitch ball between said towing position and said storage position.

20. A hitch assembly, comprising:
a frame;
a hitch ball; and
an air bag held in said frame for selectively displacing said hitch ball between a towing position and a storage position.

21. The hitch assembly of claim 20, further including a pump and a valve for expanding and contracting said air bag.

22. The hitch assembly of claim 21, further including means for guiding said hitch ball between said towing position and said storage position.

23. A method of raising and lowering a hitch ball between towing and storage positions, comprising:
filling an expandable body with fluid to raise said hitch ball; and
releasing fluid from an expandable body to lower said hitch ball.

24. A method of raising and lowering a hitch ball between towing and storage positions, comprising:
positioning and controllably filling an expandable body with fluid to raise said hitch ball; and
releasing fluid from an expandable body to lower said hitch ball.
